(19) United States
(12) Patent Application Publication
(10) Pub. No.: US 2024/0228228 A1
(43) Pub. Date: Jul. 11, 2024

(54) STATIONARY MECHANICAL BRAKE FOR LINEAR MOTOR ELEVATORS

(71) Applicant: DESIRD TASARIM ARGE ANONIM SIRKETI, Muratpasa, Antalya (TR)

(72) Inventors: Sandor Andras MARKON, Kyoto (JP); Ahmet ONAT, Istanbul (TR); Ender KAZAN, Muratpasa, Antalya (TR); Emre UZUNOGULLARI, Muratpasa, Antalya (TR)

(21) Appl. No.: 18/558,914

(22) PCT Filed: Dec. 30, 2021
(86) PCT No.: PCT/TR2021/051616

§ 371 Date: Nov. 3, 2023

(51) Int. Cl. B66B 1/36; B66B 11/04

(52) U.S. Cl. CPC B66B 1/365; B66B 11/0407

(57) ABSTRACT

Disclosed is a stationary mechanical brake system providing safe and reliable braking for linear motor elevators. The stationary mechanical brake system is also used by single-car or multi-car linear motor elevators operating on linear, curved, or branching trajectories.

### TECHNICAL FIELD

The invention relates to a stationary mechanical brake system providing safe and reliable braking for linear motor elevators. The stationary mechanical brake system is also used by single-car or multi-car linear motor elevators operating on linear, curved, or branching trajectories.

### THE STATE OF ART

Linear motor elevators, being self-propelled, offer various benefits such as the capability of operating several elevators independently in the same hoistway, and potentially operating in curved travel paths. At the same time, they must satisfy safety requirements to the same or higher level as traditional traction-driven or hydraulic elevators. One specific area requiring new solutions is the provision of stationary mechanical brake system.

Traction elevators are equipped with at least one mechanical brake system, typically attached to the shaft of the traction sheave or the motor. This brake system is normally closed by a brake spring, and electrically opened by a solenoid to enable the running of the elevator. It is also equipped with a microswitch that verifies the open or closed state of the brake for the purpose of safe operation by the elevator controller. The electrical connections to the solenoid and to the brake operation sensing microswitch are provided by stationary wirings between the elevator controller and the stationary brake system.

In case of rope-less linear motor elevators, each cabin would need to carry its mechanical brake system to preserve equivalence with traction elevators. While the cabin is running, its brake is opened by the solenoid; when it stops, the solenoid current is cut and the brake engages, to hold the cabin without requiring propulsive force by the linear motor. In case of power loss or other abnormal situation, the same mechanical brake system ensures keeping the cabin stationary, or for stopping it by emergency braking. However, the cabins have no wired connection to the elevator controller, and power transfer and communication needs to be operated by wireless connections or sliding connectors. While these are useful for most purposes, their reliability is difficult to guarantee for safety applications, such as brake operation. For example, momentary loss of power during fullspeed running will have no significant effect on other devices on the cabin such as lighting or air conditioning, but might result in momentary engagement of the brake, causing abrupt deceleration and endangering the passengers.

As a result, an improvement needs to be made since present applications cannot solve problems in the technical field.

### THE PURPOSE OF THE INVENTION

The invention aims to bring a solution for the negative aspects for a stationary mechanical brake system stated above, constructed with the inspiration from the current state of art.

The main object of the invention is to provide a system for a stationary brake for linear motor elevators in order to open or close the brakes while detecting the presence or absence of elevator cabins.

Another object of the invention is to provide a safe and reliable mechanical stationary brake solution to linear motor elevators. The disclosed stationary mechanical brake system is also used for single-car or multi-car linear motor elevators.

The structural and characteristic features and all advantages of the invention outlined in the drawings below and in the detailed description made by referring these figures will be understood clearly, therefore the evaluation should be made by taking these figures and detailed explanation into consideration.

### BRIEF DESCRIPTION OF THE FIGURES

FIG. 1 illustrates an overview of part of a preferred embodiment. It is a side view of the stationary brake assembly at one of the landings, with the elevator cab stopped and held stationary, and the solenoids in unenergized state.

FIG. 2 illustrates an overview of part of a preferred embodiment. It is a side view of the stationary brake assembly at one of the landings, with the elevator cab ready to run, being held by the linear motor (not shown), and the solenoids in energized state.

FIG. 3 illustrates a fully mechanical embodiment of the brake extender. When there is no brake plate present, the flaps of the brake extender are horizontal, and even if the plungers are de-energized, the brake extender will prevent the brake pads to come into the closed position.

FIG. 4 illustrates the brake extender with a brake plate entering from above. The top side flaps are bent down, but the brake pads are held in the open position by the bottom flaps. Thus the brake plate can continue entering into between the brake pads.

FIG. 5 illustrates the brake extender with a brake plate crossing through it from above. Both the top side flaps and bottom flaps are bent down, so the brake pads are held in the open position by the plungers if energized. If the plungers are de-energized, this status is momentary before the brake pads close onto the brake plate.

FIG. 6 illustrates the brake extender with a brake plate engaged by the brake plates.

### REFERENCE NUMBERS

1 Brake plate
2 Brake pad
3 Brake actuator
4 Brake spring
5 Brake extender

### DETAILED EXPLANATION OF THE INVENTION

In this section, the preferred embodiment of the stationary mechanical brake system is clarified such that there is no limiting effect for the sake of better understanding the subject. This part is a detailed description of exemplary embodiments to illustrate the principles of the invention.

The term “brake” is a mechanical device capable of holding the elevator cabin by frictional forces between components installed on the cabin and components installed on the building. The brake typically consists of a pair or multiple pairs of brake pads compressed by spring force, and a brake plate, disk, or other similar component that is located between the brake pads.

The term “brake system” is an electromechanical system consisting of the brake, its operating electrical actuator, its electrical status sensing switch, and possibly other components.

The term “stationary brake system” is a brake system where the brake pads and its operating electrical actuator are installed on the building side.

The term “stationary brake” is broadly defined to include any kind of brake system capable of engaging and holding a brake plate attached to the cabin; including but not restricted to disk-type brakes and drum-type brakes.

The term “brake extender” is a mechanical or electro-mechanical device capable of detecting the presence of a brake plate and disabling the closing of the brake when the brake plate is not detected to be present.

The term “linear motor elevator drive” collectively defines the stator or multiple stators, and the mover or multiple movers, together capable of holding and moving an elevator cabin or a multiplicity of elevator cabins.

The invention relates to a stationary mechanical brake system providing safe and reliable braking for linear motor elevators. The stationary mechanical brake system comprises at least one brake plate (1) which is fixed to the elevator cabin and capable of holding the total weight of the elevator. The brake plate (1) equivalent to brake disks in prior art.

There is at least one pair of brake pads (2) in the stationary mechanical brake system. In each side of the brake plate (1), each of the brake pads (2) is located. The brake pads (2) are also fixed to the building side.

The stationary mechanical brake system also comprises at least one pair of brake springs (4). Each brake spring (4) is attached with each brake pad (2). The friction with the brake plate (1) holds the elevator in stationary position when pressed to the brake plate (1) by the brake springs (4). The brake springs (4) are fixed to the building side, when at least one brake actuator (3) is not energized (which is the normal state), presses the brake pads (2) against the brake plate (1) and holds the brake plate (1) and thus the elevator cabin in fixed position. The brake actuator (3) is fixed to the building side. When energized disengages the brake pads (2) from the brake plate (1) and allows free movement for the elevator cabin.

The stationary mechanical brake system also comprises at least one pair brake extender (5) for keeping the brake pads (2) in the open position in the absence of a brake plate (1). The brake extenders (5) are located at both sides of the brake pads (2).

The brake extenders (5) are fixed to the building side. When the brake plate (1) is absent from between the brake pads (2), the brake extender (5) prevents the brake springs (4) to close the brake pads (2) even when the brake actuator (3) is not energized; and thus prevents the stationary brake system to close prematurely. The brake extender (5) serves to prevent the closing of the brake pads (2) when the brake plate (1) is absent. In this sense, the brake extender (5) functions in such a way as to keep the system in the open position when the brake actuator (3) is not energized. Preventing the brake springs (4) to close the brake pads (2) allows the stationary mechanical brake system to work correctly in case of a sudden power loss or other event that causes the brake actuators (3) to release the brake pads (2) while the elevator cabin is traveling and is in a position where the brake plate (1) is not yet between the brake pads (2). In such a situation, the elevator cabin will after a while start moving downwards and the brake plate (1) will after a while arrive between the brake pads (2). At that point, after the brake extenders (5) at both sides of the brake pads (2) detected the presence of the brake plate (1), they will release the brake pads (2) and the brake springs (4) will close them over the brake plate (1). Without the brake extender (5), in the above-described situation, the brake pads (2) would close even without the brake plate (1) being between them. When finally the brake plate (1) arrives, it will collide with the edge of the brake pads (2), and either suffer a sudden abrupt deceleration, or destroys the brake pads (2) and continues falling. Both outcomes are undesirable, and the brake extender (5) serves to prevent such accidents.

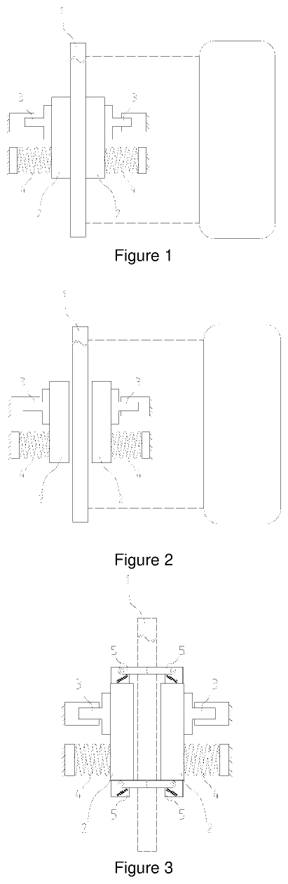

The stationary brakes are installed at suitable locations to stop the elevator cabin. The brake plate (1) installed on the cabin has a length longer than the distance between any two consecutive brakes, thus at any position the brake plate (1) is in reach of at least one brake. When the cabin is stationary, the brake solenoid is de-energized and the brake is engaged, holding the cabin (FIG. 1). Solenoids, sub-component of the brake actuator (3), are electrical parts inside the brake actuator (3) that open and close the brake. During normal operation, whenever the elevator cabin needs to move, the linear motor is powered up to provide a propulsive force equal to the total weight of the cabin. In that state, there is no load on the brake, and it can be opened by energizing the solenoids (FIG. 2). Subsequently, all brakes along the travel of the cabin are also opened, and the cabin can be freely moved to its destination. However, if during running there is a power failure, the brake solenoids are de-energized and the brake pads (2) would close. The brake plate (1) on the elevator cabin then would collide with the next brake, damaging the equipment and presenting a danger to the passengers with sudden deceleration. To prevent this, the stationary brakes are equipped with brake extenders (5) on the top and bottom (FIG. 3). The equipment and presenting a danger to the passengers with sudden deceleration. To prevent this, the stationary brakes are equipped with brake extenders on the top and bottom (FIG. 3).

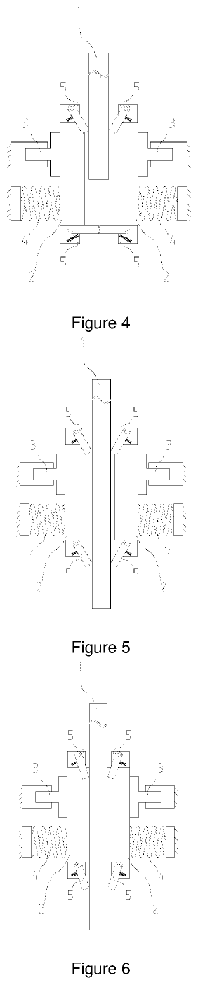

The brake extender (5) in the invention has two flaps, that in the absence of the brake plate (1) can touch each other when the solenoid is de-energized, preventing the brake pads (2) from closing. When the brake plate (1) enters between the brake pads (2), it deflects first one of the brake extenders (5) (in FIG. 4, the top one) then the other (in FIG. 5, the bottom one). In this situation, the stationary brake system becomes capable of normal operation, keeping open when the solenoid is energized and engaging when the solenoid is de-energized (FIG. 6).

Due to the installation of the brake extender (5), the stationary mechanical brake system can perform all the required operations:
Engage and disengage at a stopping floor,
Keep out of the way of the passing elevator car at floors on the way,
Catch and decelerate the elevator in the event of a power failure.

One of the embodiments of the brake extender (5) (not depicted in figures) use an increased stroke for the opening plunger, large enough so the fully opened brake system also opens up the brake extender (5) flaps sufficiently for the brake plate (1) to pass between them. This embodiment will prevent the brake plate (1) hitting the extender flaps during normal operation; while in case of power failure, the brake flaps will prevent the brake pads (2) from closing until the brake plate (1) arrives between them. However, in this case the shape of the brake flaps must be designed in such a way that they will not prevent the closing of the brake pads (2) in the event that the brake plate (1) is already between them at the moment of closing (i.e. de-energizing the solenoid).

One of the embodiments of the brake extender (5) (not depicted in figures) use a fast-acting electric actuator to keep them open in case of normal operation, for the same purpose described in the preceding paragraph. In case of power failure, the brake flaps will be returned to normal position faster than the closing speed of the brake pads, preventing them from closing until the brake plate (1) arrives.

One or more optical sensors and/or magnetic sensors can be used for detecting the presence or absence of the brake plate (1) in one embodiment of the stationary mechanical brake system.

The embodiments are provided to illustrate aspects of the invention, but the invention is not limited to any embodiment. In other words, the embodiments disclosed are illustrative, not restrictive.

While specific configurations/embodiments of the stationary brake system have been described, it is understood that the present invention can be applied to a wide variety of elevator systems. The stationary brake system according to the invention is also suitable for non-linear (curved) movement paths of the linear motor elevator, or for movements along branching paths with switches.

There are many alternative ways of implementing the invention, including but not limited to having different mechanisms transferring the movements of the movers to the brake system. Numerous specific details are set forth in the description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured. However, many other equivalent mechanisms can be substituted for the illustrated embodiment, among them linkages, rack-and-pinion mechanism, and so on, easily selected by a mechanical engineer.

The scope of the invention encompasses numerous alternatives, modifications, and equivalents; it is defined only by the claims.

In order to fulfill all aims of the invention and solve the problems of the state of art, the invention is a stationary mechanical brake system suitable for linear motor elevator, comprising:
at least one brake plate (1) attached to the elevator cabin,
at least one pair of brake pads (2) attached to the brake springs (2) and opening solenoids, and
at least one pair of brake extender (5) for keeping the brake pads (2) in the open position in the absence of a brake plate (1).

To solve the problems of the state of art, the invention is a stationary mechanical brake system wherein the brake extender (5) has two flaps, that in the absence of the brake plate (1) can touch each other when the solenoid is de-energized, preventing the brake pads (2) from closing.

To solve the problems of the state of art, the invention is a stationary mechanical brake system comprising: one or more optical sensors and/or magnetic sensors for detecting the presence or absence of the brake plate (1).

To solve the problems of the state of art, the invention is a brake system, wherein,
multiple elevator cabins are installed in the same hoistway,
each of them is equipped with brake plates (1), and
each of the brake plates (1) are arranged to be held or released by the same set of stationary brakes.

To solve the problems of the state of art, the invention is a rope-less linear motor elevator system comprising:
At least one stationary mechanical brake system,
a linear motor drive system, and
an elevator cabin.

To solve the problems of the state of art, the invention is a rope-less multi-car linear motor elevator system comprising:
At least one stationary mechanical brake system,
a linear motor drive system, and
a plurality of elevator cabins.

1. A stationary mechanical brake system suitable for linear motor elevator, the system comprising:
at least one brake plate attached to an elevator cabin;
at least one pair of brake pads attached to brake springs and opening solenoids; and
at least one pair of brake extender for keeping the brake pads in the open position in the absence of a brake plate.

2. A stationary mechanical brake system according to claim 1, wherein the brake extender has two flaps, that in the absence of the brake plate can touch each other when the solenoid is de-energized, preventing the brake pads from closing.

3. A stationary mechanical brake system according to claim 1, comprising: one or more optical sensors and/or magnetic sensors for detecting the presence or absence of the brake plate.

4. A brake system of according to claim 1, wherein;
multiple elevator cabins are installed in the same hoistway;
each of the multiple elevator cabins are equipped with brake plates; and
each of the brake plates are arranged to be held or released by the same set of stationary brakes.

5. A rope-less linear motor elevator system comprising:
at least one stationary mechanical brake system according to claim 1;
a linear motor drive system; and
an elevator cabin.

6. A rope-less multi-car linear motor elevator system comprising:
at least one stationary mechanical brake system according to claim 1;
a linear motor drive system; and
a plurality of elevator cabins.
